(19) United States
(12) Patent Application Publication
(10) Pub. No.: US 2012/0120339 A1
(43) Pub. Date: May 17, 2012

(54) LIQUID CRYSTAL DISPLAY DEVICE

(75) Inventors: Jeung-Soo KIM, Yongin-City (KR); Kyu-Han BAE, Yongin-City (KR)

(73) Assignee: SAMSUNG MOBILE DISPLAY CO., LTD., Yongin-City (KR)

(21) Appl. No.: 13/028,737

(22) Filed: Feb. 16, 2011

(30) Foreign Application Priority Data
Nov. 12, 2010 (KR) 10-2010-0112999

(51) Int. Cl. G02F 1/1333

(52) U.S. Cl. 349/58

(57) ABSTRACT

A liquid crystal display (LCD) device with reduced defects due to a reduced stress between corners of an LCD panel assembly and a molded frame. The LCD device includes an LCD panel assembly; and a molded frame that houses the LCD panel assembly, wherein the molded frame includes: sidewalls surrounding outer surfaces of the LCD panel assembly; settling units protruding from at least one of corners of the sidewalls corresponding to bottom corners of the LCD panel assembly; and escape grooves recessed in a rearward direction in at least one of the settling units.

### CLAIM OF PRIORITY

This application claims the benefit of Korean Patent Application No. 10-2010-0112999 filed on Nov. 12, 2010 the Korean Intellectual Property Office, the disclosure of which is incorporated herein in its entirety by reference.

### BACKGROUND OF THE INVENTION

1. Field of the Invention

The present invention relates to a liquid crystal display (LCD) device including a molded frame.

2. Description of the Related Art

Liquid crystal display (LCD) devices are being used as flat panel display devices since they may resolve problems of cathode ray tube (CRT) display apparatuses due to having smaller sizes, lighter weights, smaller thicknesses, and lower power consumption. Generally, an LCD device is a display device that can change arrangements of liquid crystal molecules, which have material properties between those of liquids and those of solids, in liquid crystal cells by applying an external electric field to change optical properties including double refraction, circumpolarization, and light diffusion properties of the liquid crystal cells. Recently, for miniaturization of an LCD device, continuous research is being performed on components constituting an LCD device, e.g., a backlight, a connector, a printed circuit board (PCB), and a combination structure.

Various tests are performed to evaluate mechanical reliability of an LCD device while the LCD device is being manufactured. These tests may include a twist test that inserts a glass substrate corresponding to an LCD panel assembly into a molded frame and applying a force in a predetermined direction. Here, cracks are formed at corners of the glass substrate due to stress between the glass substrate and the molded frame, and formation of the cracks is accelerated as the twist test is continued, and thus the cracks spread throughout the glass substrate. Furthermore, if an LCD panel assembly is inserted into a molded frame, cracks may be formed at corners of the LCD panel assembly due to stress between the LCD panel assembly and the molded frame.

The above information disclosed in this Related Art section is only for enhancement of understanding of the background of the invention and therefore it may contain information that does not form the prior art that is already known to a person of ordinary skill in the art.

### SUMMARY OF THE INVENTION

The present invention provides for exemplary embodiments in which a liquid crystal display (LCD) device with reduced defects due to reduced stress between corners of an LCD panel assembly and a molded frame.

According to an aspect of the present invention, there is provided a liquid crystal display (LCD) device that may include an LCD panel assembly; and a molded frame that houses the LCD panel assembly, wherein the molded frame may include sidewalls surrounding outer surfaces of the LCD panel assembly; settling units protruding from at least one of corners of the sidewalls corresponding to bottom corners of the LCD panel assembly; and escape grooves recessed in a rearward direction in at least one of the settling units.

The LCD device may further include supporting units that support bottom edges of the LCD panel assembly and protrude inward from the sidewalls, wherein the supporting units and the settling units may be continuously formed.

The sidewalls may include first and second long sides extending in parallel to each other; and first and second short sides extending in a direction perpendicular to the first and second long sides, and the corners of the sidewalls formed at points where the first and second long sides and the first and second short sides cross each other.

The settling units may include a first settling unit formed at a point at which the first long side and the first short side cross each other; a second settling unit may be formed at a point at which the first long side and the second short side cross each other; a third settling unit may be formed at a point at which the second long side and the first short side cross each other; and a fourth settling unit may be formed at a point at which the second long side and the second short side cross each other.

The escape grooves may be formed in the first settling unit, the second settling unit, the third settling unit, and the fourth settling unit.

The escape grooves may be formed in the first settling unit and the fourth settling unit or are formed in the second settling unit and the third settling unit.

The settling units may include a first settling unit formed at a point at which the first long side and the first short side cross each other; and a fourth settling unit formed at a point at which the second long side and the second short side cross each other.

The escape grooves may be formed in the first settling unit and the fourth settling unit.

The settling units may include a second settling unit formed at a point at which the first long side and the second short side cross each other; a third settling unit formed at a point at which the second long side and the first short side cross each other.

The escape grooves may be formed in the second settling unit and the third settling unit.

The escape grooves may be formed in the settling units to contact the sidewalls.

The escape grooves may have polygonal cross-sections in a lengthwise direction.

Gaps may be formed between the bottom corners of the LCD panel assembly and the settling units.

The LCD device may further include a backlight assembly that generates light, wherein the backlight assembly may be arranged below the LED panel assembly and is housed in the molded frame, such that the supporting units surrounds outer side surfaces of the backlight assembly.

The LCD device may further include a bezel that surrounds outer side surfaces of the molded frame and houses the molded frame.

According to an aspect of the present invention, there is provided a display device that may include a display panel assembly that displays an image having a rectangular shape and a molded frame that houses the display panel assembly. The molded frame may include sidewalls surrounding outer surfaces of the display panel assembly. Settling units may be provided that protrud from each corner of the sidewalls supporting corners of the display panel assembly and forming greater than a 90° angle with adjacent sidewalls to which the settling units are connected. Escape grooves may be recessed in at least two of the settling units in diagonally opposed corners of the molded frame in which the escape grooves have a depth equivalent to at least about 10% a thickness of the settling units.

Aspects of the display device may have the escape grooves recessed in each and every settling unit.

Aspects of the display device may have the escape grooves having a depth equivalent of no greater than about 70% the thickness of the settling units.

Aspects of the display device may have the escape grooves having a polygonal cross-sections in a lengthwise direction.

Aspects of the display device may have partial gaps formed between the corners of the display panel assembly and the settling units.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic exploded perspective view of a liquid crystal display (LCD) device according to an embodiment of the present invention;

FIG. 2 is a sectional view taken along a line II-II′ of FIG. 1;

FIG. 3 is a schematic plan view of a molded frame included in the LCD device of FIG. 1; and

FIGS. 4 through 7 show molded frames according to other embodiments of the present invention.

### DETAILED DESCRIPTION OF THE INVENTION

The present invention now will be described more fully hereinafter with reference to the accompanying drawings, in which illustrative embodiments of the invention are shown. The present invention may, however, be embodied in many different forms and should not be construed as limited to the embodiments set forth herein; rather, these embodiments are provided so that this disclosure will be thorough and complete, and will fully convey the scope of the present invention to those skilled in the art. In the description of the present invention, if it is determined that a detailed description of commonly-used technologies or structures related to the invention may unnecessarily obscure the subject matter of the invention, the detailed description may be omitted.

It will be understood that although the terms first and second are used herein to describe various elements, these elements should not and are not limited by these terms. These terms are only used to distinguish one element from another element.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

Hereinafter, the present invention will be described in detail by explaining exemplary embodiments of the invention with reference to the attached drawings.

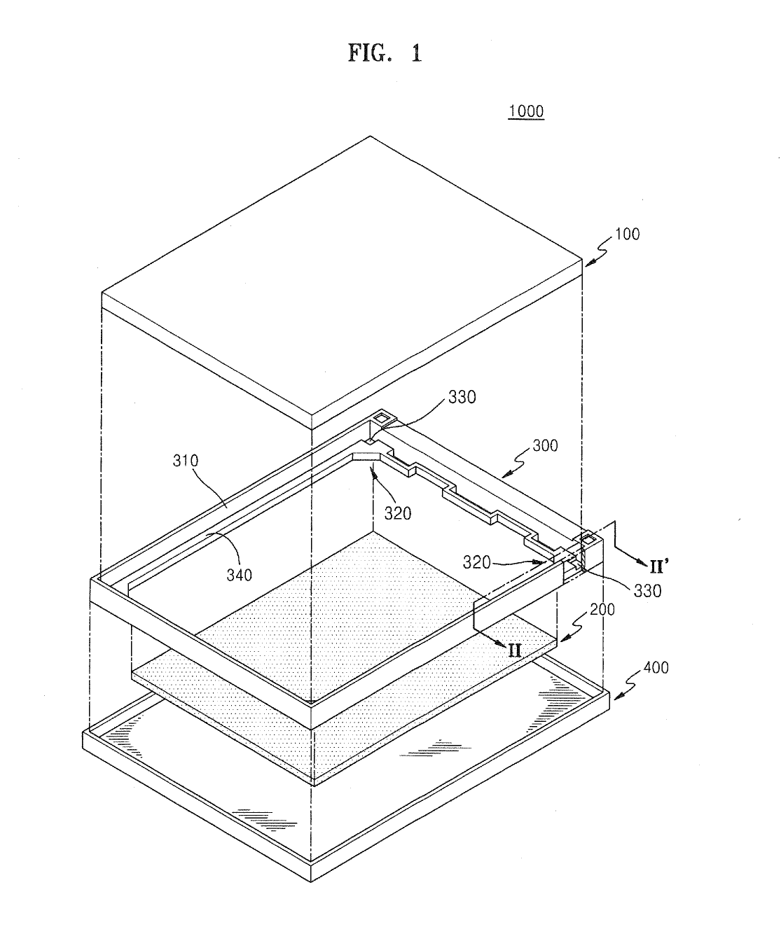

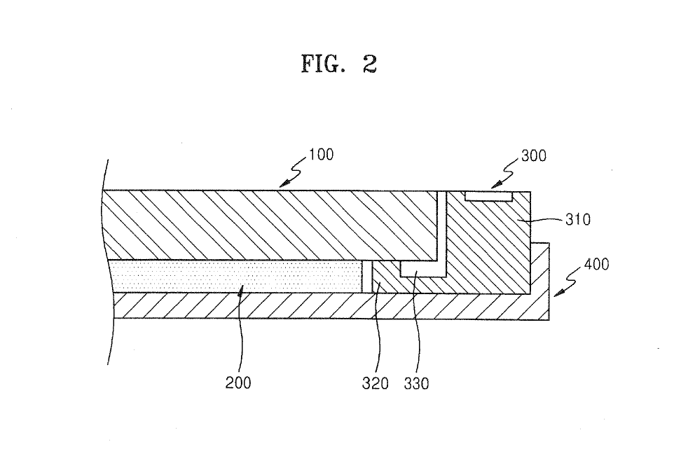

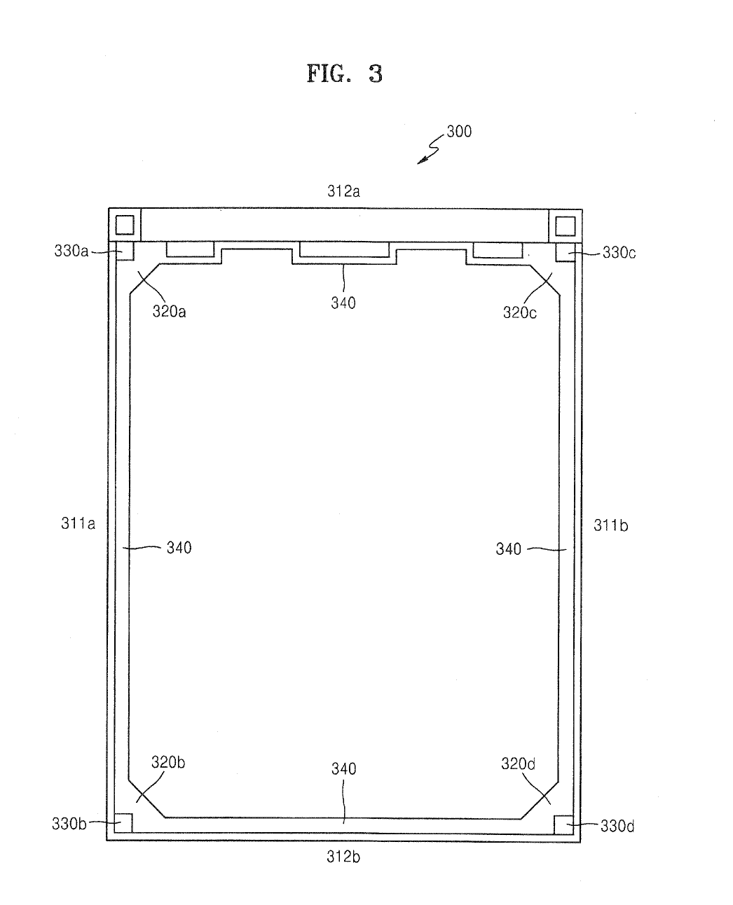

FIG. 1 is a schematic exploded perspective view of a liquid crystal display (LCD) device 1000 according to an embodiment of the present invention. Furthermore, FIG. 2 is a sectional view taken along a line II-II′ of FIG. 1. FIG. 3 is a schematic plan view of a molded frame 300 included in the LCD device 1000 of FIG. 1.

Referring to FIGS. 1 through 3, the LCD device 1000 according to the present embodiment may include an LCD panel assembly 100, a backlight assembly 200, the molded frame 300, and a bezel 400.

The LCD panel assembly 100 displays an image via a display region (not shown). Although not shown, the LCD panel assembly 100 may further include an LCD panel for displaying an image by transmitting or blocking light by using liquid crystals having molecule arrangements that are changed by an electric field or a magnetic field applied thereto, a bottom polarization film arranged below the LCD panel, and a top polarization film arranged on the LCD panel.

The backlight assembly 200 may be arranged below the LCD panel assembly 100 and irradiates light to the LCD panel assembly 100. Although not shown, the backlight assembly 200 may further include a light source for generating light and a light guiding plate that guides light generated by the light source and outputs the guided light toward the LCD panel assembly 100. Here, the light source may be, but not limited to, a light emitting diode (LED), as a point light source for the backlight assembly 200. Optical sheets (not shown) may be further arranged on bottom and top surfaces of the light guiding plate in order to improve light extraction efficiency. For example, the optical sheets may include a reflection sheet (not shown) that reflects light leaked from the bottom surface of the light guiding plate toward the light guiding plate, a diffusion sheet (not shown) that diffuses light output from the top surface of the light guiding plate, and vertical and horizontal prism sheets (not shown) that concentrate light output by the diffusion sheet.

The molded frame 300 houses the LCD panel assembly 100 and the backlight assembly 200, and more particularly, combines the LCD panel assembly 100 and the backlight assembly 200 in a vertical direction. Here, the backlight assembly 200 may be arranged below the LCD panel assembly 100. The molded frame 300 may support and fix the LCD panel assembly 100 and the backlight assembly 200 and prevents the LCD panel assembly 100 and the backlight assembly 200 from being damaged by external vibrations and shocks. The molded frame 300 may be a rectangular frame having an open top surface and an open bottom surface.

The bezel 400 surrounds outer surfaces of the molded frame 300 and physically supports the molded frame 300.

The molded frame 300 according to the present exemplary embodiment may include sidewalls 310 surrounding outer side surfaces of the LCD panel assembly 100, supporting units 340 that support bottom edges of the LCD panel assembly 100 and protrude inward from the sidewalls 310, and settling units 320 protruding inward from at least one of corners of the sidewalls 310 corresponding to bottom corners of the LCD panel assembly 100, wherein an escape groove 330 recessed in a rearward direction may be formed in at least one of the settling units 320. The settling units may form an approximate greater than 90° angle with adjacent supporting units 340 to which they are connected, thus forming a wedge-like structure.

The sidewalls 310 may include a first long side 311a and a second long side 311b that extend in parallel to each other to surround outer sidewalls of the LCD panel assembly 100, and a first short side 312a and a second short side 312b that extend in a direction perpendicular to the first and second long sides 311a and 311b. A height of the sidewalls 310 may be greater than a sum of a thickness of the LCD panel assembly 100 and a thickness of the backlight assembly 200, so that the LCD panel assembly 100 and the backlight assembly 200 may be stably housed. The corners of the sidewalls 310 are formed at points at which the first long side 311a, the second long side 311b, the first short side 312a, and the second short side 312b cross each other. According to an embodiment of the present invention, the molded frame 300 has a rectangular frame, and thus four corners may be formed.

The setting units 320 are formed at the corners of the sidewalls 310 to protrude inward from the sidewalls 310 at an approximately greater than 90° angle with adjacent sidewalls 310. Here, the inward direction refers to a direction toward the LCD panel assembly 100. Since the bottom corners of the LCD panel assembly 100 correspond to the corners of the sidewalls 310, the setting units 320 and the bottom corners of the LCD panel assembly 100 contact each other, and thus the settling units 320 support and fix the LCD panel assembly 100. Referring to FIG. 2, which is taken along the line II-II′ of FIG. 1, since corners of the molded frame 300 include the sidewalls 310 and the setting units 320, the corners of the molded frame 300 may have L-shaped cross-sections. On the other hand, when a twisting force or a horizontal or vertical force is applied to the LCD device 1000, cracks may be formed in the LCD panel assembly 100 due to stresses between the settling units 320 and the bottom corners of the LCD panel assembly 100. According to an exemplary embodiment of the present invention, the escape grooves 330 are formed in the settling units 320.

The escape grooves 330 are recessed in the rearward direction. Here, the rearward direction refers to a direction toward a bottom surface of the bezel 400 when the molded frame 300 is combined with the bezel 400. Therefore, gaps are formed between the bottom corners of the LCD panel assembly 100 and the settling units 320 due to the escape grooves 330. As a result, since the escape grooves 330 are formed, stresses between the corners of the LCD panel assembly 100 and the settling units 320 are reduced when a twist or horizontal or vertical vibrations are applied to the LCD device 1000, and thus cracks may not be formed in the LCD panel assembly 100.

Referring to FIG. 2, the escape grooves 330 are formed in the settling units 320 to contact the sidewalls 310. Here, the escape grooves 330 may have polygonal cross-sections in a lengthwise direction. For example, if the escape grooves 330 have rectangular cross-sections in the lengthwise direction, two adjacent sides of the rectangular escape grooves 330 may contact the sidewalls 310. Since the escape grooves 330 are formed to contact the sidewalls 310, direct contact between the bottom corners of the LCD panel assembly 100, which are vulnerable to stress, and the settling units 320 may be prevented. Although the sections of the escape grooves 330 in the lengthwise direction are shown as rectangles, the present invention is not limited thereto. The sections of the escape grooves 330 in the lengthwise direction may have any of various shapes. A depth of the escape grooves 330 may vary according to a size and a structure of the LCD device 1000. According to an embodiment of the present invention, the escape grooves 330 may have a depth equivalent to about 10% to about 70% of a thickness of the settling units 320. If the escape grooves 330 have an insufficient depth, the corners of the LCD panel assembly 100 and bottom surfaces of the escape grooves 330 may contact each other, and thus the corners of the LCD panel assembly 100 may be damaged.

Although the escape grooves 330 are provided in the present exemplary embodiment, the present invention is not limited thereto. According to another exemplary embodiment of the present invention, escape holes (not shown) penetrating the settling units 320 in the rearward direction may be formed in the settling units 320 instead of the escape grooves 330. Thus, the aforementioned escape holes would surpass the aforementioned depth equivalent of about 10% to about 70% of a thickness of the settling units 320 and entirely penetrate through the settling units 320.

The supporting units 340 protrudes inward from the sidewalls 310 and supports the bottom edges of the LCD panel assembly 100. The LCD panel assembly 100 is fixed and supported by the supporting units 340. The supporting units 340 may be formed with the first long side 311a, the second long side 311b, the first short side 312a, and the second short side 312b of the sidewalls 310. Meanwhile, the supporting units 340 and the settling units 320 may be continuously formed. Although not shown, sides of the molded frame 300 include the sidewalls 310 and the supporting units 340, and thus the sides of the molded frame 300 may have L-shaped cross-sections. The supporting units 340 may be formed to surround outer side surfaces of the backlight assembly 200. The supporting units 340 may fix the backlight assembly 200.

As described above, FIGS. 1 and 2 show that the molded frame 300 is a rectangular frame having an open top surface and an open bottom surface. However, the present invention is not limited thereto.

Hereinafter, detailed descriptions of the molded frame 300 including the settling units 320 and the escape grooves 330 according to various embodiments of the present invention will be given. For convenience of explanation, descriptions below will focus on the shape of the molded frame 300.

Referring to FIG. 3, the molded frame 300 according to an exemplary embodiment of the present invention is shown. According to the present embodiment, the settling units 320 may include a first settling unit 320a formed at a point at which the first long side 311a and the first short side 312a cross each other, a second settling unit 320b may be formed at a point at which the first long side 311a and the second short side 312b cross each other, a third settling unit 320c may be formed at a point at which the second long side 311b and the first short side 312a cross each other, and a fourth settling unit 320d may be formed at a point at which the second long side 311b and the second short side 312b cross each other. According to the present embodiment, the escape grooves 330 may be formed in all of the first settling unit 320a, the second settling unit 320b, the third settling unit 320c, and the fourth settling unit 320d. Hereinafter, the escape groove 330 formed in the first settling unit 320a will be referred to as a first escape groove 330a, the escape groove 330 formed in the second settling unit 320b will be referred to as a second escape groove 330b, the escape groove 330 formed in the third settling unit 320c will be referred to as a third escape groove 330c, and the escape groove 330 formed in the fourth settling unit 320d will be referred to as a fourth escape groove 330d.

In the embodiment shown in FIG. 3, all of the four corners of the LCD panel assembly 100 are settled and stably fixed on the settling units 320. Furthermore, the escape grooves 330 are formed in all of the settling units 320, so that formation of cracks in the LCD panel assembly 100 may be prevented.

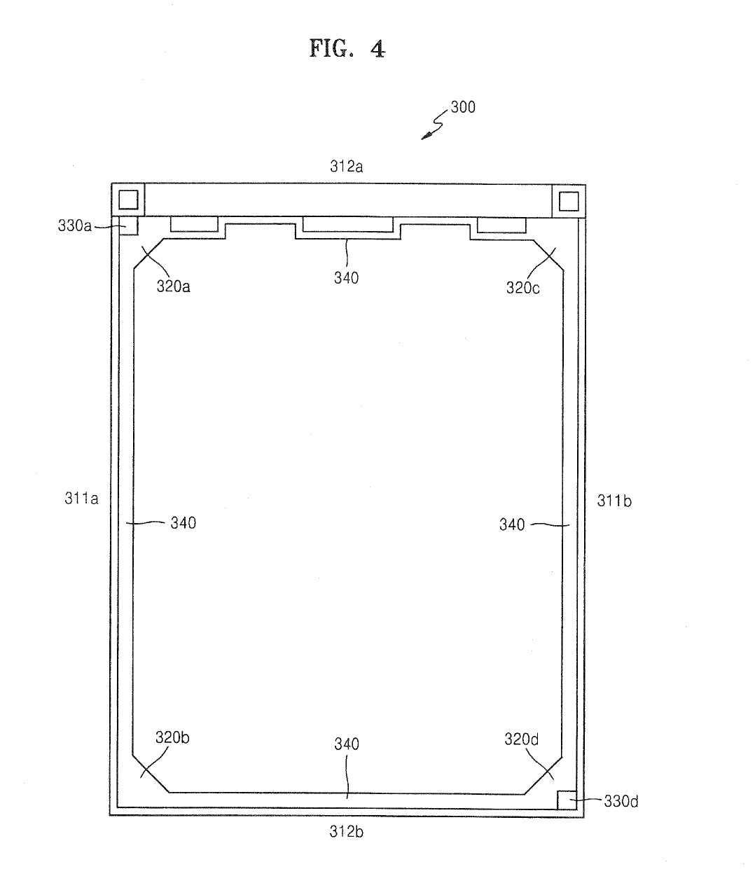

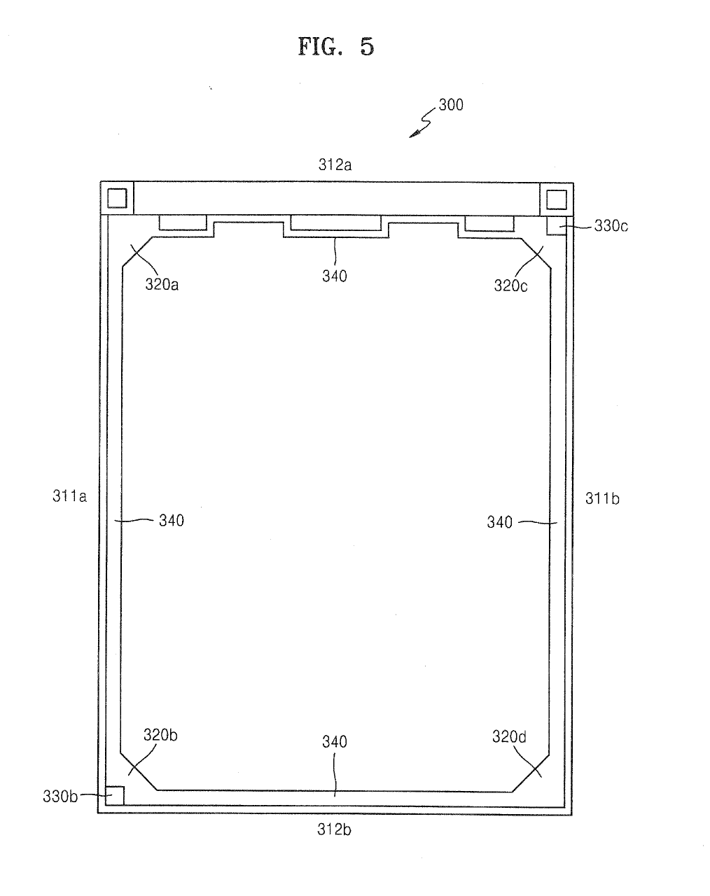

FIGS. 4 and 5 show the molded frame 300 according to other embodiments of the present invention.

Referring to FIG. 4, the settling units 320 may include the first settling unit 320a formed at a point at which the first long side 311a and the first short side 312a cross each other, the second settling unit 320b may be formed at a point at which the first long side 311a and the second short side 312b cross each other, the third settling unit 320c may be formed at a point at which the second long side 311b and the first short side 312a cross each other, and the fourth settling unit 320d may be formed at a point at which the second long side 311b and the second short side 312b cross each other. Compared to the embodiment shown in FIG. 3, the escape grooves 330 may only be formed in the first settling unit 320a and the fourth settling unit 320d in the present embodiment. In other words, only the first escape groove 330a and the fourth escape groove 330d are formed in FIG. 4.

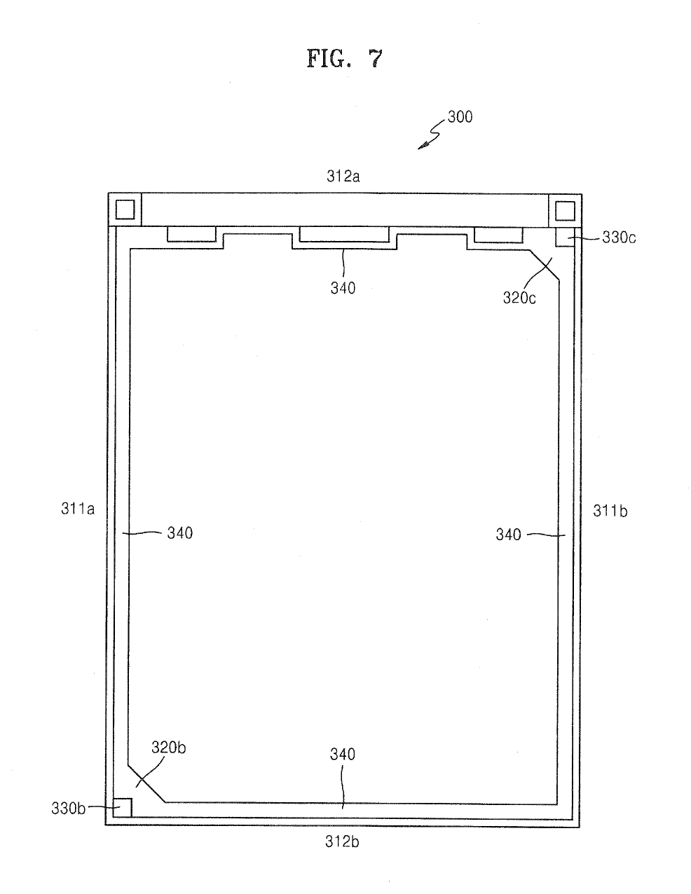

Referring to FIG. 5, the settling units 320 may include the first settling unit 320a formed at a point at which the first long side 311a and the first short side 312a cross each other, the second settling unit 320b may be formed at a point at which the first long side 311a and the second short side 312b cross each other, the third settling unit 320c may be formed at a point at which the second long side 311b and the first short side 312a cross each other, and the fourth settling unit 320d may be formed at a point at which the second long side 311b and the second short side 312b cross each other. Compared to the embodiment shown in FIG. 4, the escape grooves 330 may only be formed in the second settling unit 320b and the third settling unit 320c in the present embodiment. In other words, only the second escape groove 330b and the third escape groove 330c are formed in FIG. 7.

In the embodiments shown in FIGS. 4 and 5, all of the four corners of the LCD panel assembly 100 are settled and stably fixed on the settling units 320. Furthermore, since the escape grooves 330 are formed in a diagonal direction, a structure highly resistant to twist stress may be provided using a minimum number of the escape grooves 330.

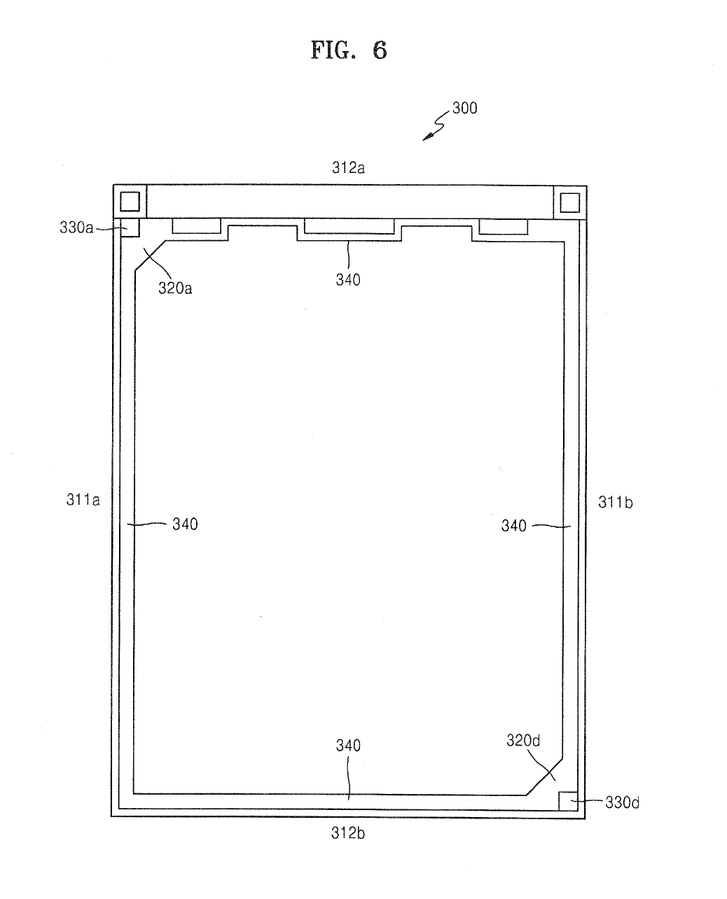

FIGS. 6 and 7 show the molded frame 300 according to other embodiments of the present invention.

Referring to FIG. 6, the settling units 320 may include the first settling unit 320a formed at a point at which the first long side 311a and the first short side 312a cross each other and the fourth settling unit 320d formed at a point at which the second long side 311b and the second short side 312b cross each other. Here, the escape grooves 330 may be formed in all of the first settling unit 320a and the fourth settling unit 320d in the present embodiment. In other words, the first escape groove 330a and the fourth escape groove 330d are formed in FIG. 6.

Referring to FIG. 7, the settling units 320 may include the second settling unit 320b formed at a point at which the first long side 311a and the second short side 312b cross each other and the third settling unit 320c formed at a point at which the second long side 311b and the first short side 312a cross each other. Here, the escape grooves 330 may be formed in all of the second settling unit 320b and the third settling unit 320c in the present embodiment. In other words, the second escape groove 330b and the third escape groove 330c are formed in FIG. 7.

In the embodiments shown in FIGS. 6 and 7, two of the four corners of the LCD panel assembly 100 in a diagonal direction are settled and stably fixed on the settling units 320. Therefore, formation of cracks due to stresses between the LCD panel assembly 100 and the settling units 320 may be reduced by using a minimum number of the escape grooves 330. Furthermore, by forming the setting units 320 in a diagonal direction, the LCD panel assembly 100 may be more stably fixed. The escape grooves 320 may be formed in all of the settling units 320 to prevent formation of cracks in the LCD panel assembly 100 due to the settling units 320.

As described above, according to an embodiment of the present invention, as the escape grooves 330 may be formed in the settling units 320 of the molded frame 300, contacting areas and stresses between the corners of the LCD panel assembly 100 and the molded frame 300 are reduced and formation of cracks due to horizontal or vertical vibrations or shocks may be reduced. As a result, an LCD device that is stable against vibrations and shocks and that has reduced amounts of defects may be provided.

Particularly, the molded frame 300 according to the present invention may prevent formation of cracks in a glass substrate in a twist test performed during a process of manufacturing the LCD device 1000. In detail, when a glass substrate is arranged in a molded frame 300 including the escape grooves 330 according to the present invention and a twisting force is applied to the molded frame 300, stresses between bottom corners of the glass substrate and the settling units 320 of the molded frame 300 are reduced by the escape grooves 330, and thus cracks are not formed in the glass substrate.

Although the descriptions above are given with respect to the LCD device 1000 as a flat panel display device, embodiments of the present invention are not limited to the LCD device 1000 and may be applied to any of other types of flat panel display devices as long as the molded frame 300 according to the present invention is applicable thereto.

According to embodiments of the present invention as described above, as escape grooves are formed in settling units of a molded frame, contacting areas and stresses between corners of an LCD panel assembly and the molded frame are reduced and formation of cracks due to horizontal or vertical vibrations or shocks may be reduced. As a result, an LCD device that is stable against vibrations and shocks and that has a reduce amount of defects may be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display (LCD) device, comprising:
a LCD panel assembly; and
a molded frame that houses the LCD panel assembly,
wherein the molded frame comprises:
sidewalls surrounding outer surfaces of the LCD panel assembly;
settling units protruding from at least one of corners of the sidewalls corresponding to bottom corners of the LCD panel assembly; and
escape grooves recessed in a rearward direction in at least one of the settling units.

2. The LCD device of claim 1, further comprising:
supporting units that support bottom edges of the LCD panel assembly and protrude inward from the sidewalls,
wherein the supporting units and the settling units are continuously formed.

3. The LCD device of claim 1, wherein the sidewalls comprise:
first and second long sides extending in parallel to each other; and
and first and second short sides extending in a direction perpendicular to the first and second long sides, and
the corners of the sidewalls are formed at points where the first and second long sides and the first and second short sides cross each other.

4. The LCD device of claim 3, wherein the settling units comprises:
a first settling unit formed at a point at which the first long side and the first short side cross each other;
a second settling unit formed at a point at which the first long side and the second short side cross each other;
a third settling unit formed at a point at which the second long side and the first short side cross each other; and
a fourth settling unit formed at a point at which the second long side and the second short side cross each other.

5. The LCD device of claim 4, wherein the escape grooves are formed in the first settling unit, the second settling unit, the third settling unit, and the fourth settling unit.

6. The LCD device of claim 4, wherein the escape grooves are formed in the first settling unit and the fourth settling unit or are formed in the second settling unit and the third settling unit.

7. The LCD device of claim 3, wherein the settling units comprises:
a first settling unit formed at a point at which the first long side and the first short side cross each other; and
a fourth settling unit formed at a point at which the second long side and the second short side cross each other.

8. The LCD device of claim 7, wherein the escape grooves are formed in the first settling unit and the fourth settling unit.

9. The LCD device of claim 3, wherein the settling units comprises:
a second settling unit formed at a point at which the first long side and the second short side cross each other;
a third settling unit formed at a point at which the second long side and the first short side cross each other.

10. The LCD device of claim 9, wherein the escape grooves are formed in the second settling unit and the third settling unit.

11. The LCD device of claim 1, wherein the escape grooves are formed in the settling units to contact the sidewalls.

12. The LCD device of claim 1, wherein the escape grooves have polygonal cross-sections in a lengthwise direction.

13. The LCD device of claim 1, wherein gaps are formed between the bottom corners of the LCD panel assembly and the settling units.

14. The LCD device of claim 2, further comprising a backlight assembly that generates light,
wherein the backlight assembly is arranged below the LED panel assembly and is housed in the molded frame, such that the supporting units surrounds outer side surfaces of the backlight assembly.

15. The LCD device of claim 1, further comprising a bezel that surrounds outer side surfaces of the molded frame and houses the molded frame.

16. A display device, comprising:
a display panel assembly that displays an image having a rectangular shape; and
a molded frame that houses the display panel assembly,
wherein the molded frame, comprises:
sidewalls surrounding outer surfaces of the display panel assembly;
settling units protruding from each corner of the sidewalls supporting corners of the display panel assembly and forming greater than a 90° angle with adjacent sidewalls to which the settling units are connected; and
escape grooves recessed in at least two of the settling units in diagonally opposed corners of the molded frame, the escape grooves have a depth equivalent to at least about 10% a thickness of the settling units.

17. The display device recited in claim 16, wherein the escape grooves are recessed in each and every settling unit.

18. The display device recited in claim 16, wherein the escape grooves have a depth equivalent of no greater than about 70% the thickness of the settling units.

19. The display device of claim 16, wherein the escape grooves have polygonal cross-sections in a lengthwise direction.

20. The display device of claim 16, wherein partial gaps are formed between the corners of the display panel assembly and the settling units.
